(19) United States
(12) Patent Application Publication
(10) Pub. No.: US 2002/0069085 A1
(43) Pub. Date: Jun. 6, 2002

(54) System and method for purchasing health-related services

(75) Inventors: Bradley C. Engel, Burlington, WI (US); Peter R. Heisen, Washington Crossing, PA (US)

Correspondence Address: Derek C. Stettner, Michael Best & Friedrich LLP, 100 East Wisconsin Avenue, Milwaukee, WI, 53202-4108, US

(73) Assignee: PatientWise Corporation

(21) Appl. No.: 09/730,254

(22) Filed: Dec. 5, 2000

(51) Int. Cl. G06F 17/60

(52) U.S. Cl. 705/2

(57) ABSTRACT

A method and system of selling healthcare services to a patient. A number of healthcare service providers are contracted and registered with a healthcare marketplace operator. Information regarding the healthcare service providers is stored in a database. A prospective patient is provided with a case statement template having one or more areas to specify clinical and non-clinical requirements of the patient. The patient uses the template to provide case statement information to the marketplace operator. In many instances, the case statement template is completed with the assistance of the patient's primary physician. The case statement information is received and processed by the marketplace operator. The marketplace operator generates a case statement from the case statement information and the case statement is made available or distributed to contracting healthcare providers. In general, the healthcare providers set a number of screening factors so that they receive case statements related to the type of medical procedures the healthcare service providers wish to perform. Interested healthcare providers then prepare proposals or responses to the patient's case statement. The responses received form the healthcare service providers are then delivered to the prospective patient. The prospective patient then reviews the responses from the healthcare providers. The responses may include clinical quality indicators such as mortality rate, physician licensing, physician and medical staff experience, malpractice claims, available medical equipment, and other relevant information. The patient may secure the services of one of the contracting service providers by submitting a deposit.

### BACKGROUND OF THE INVENTION

The present invention relates to methods and systems to market and sell healthcare services. More particularly, the present invention relates to a spot marketplace for schedulable healthcare services.

Healthcare is the single largest sector of the U.S. economy and a large sector of the world economy. It is predicted that the costs of healthcare in the U.S. will continue to rise at a rate greater than the rate of inflation. Presently, more than $1 trillion per year is spent on healthcare services in the U.S. Despite the fact that the U.S. economy is based on capitalism and free market principles, free markets for most healthcare services do not exist. Further, most healthcare policymakers and planners have assumed that free-market principles cannot be applied to healthcare services. Instead of operating on market principles, the healthcare industry is structured to suit its own convenience. In addition, the administrative complexity of the healthcare industry make it difficult for lay people to understand sufficiently in order to make informed purchasing decisions.

The perception of many consumers is that healthcare services and associated products are overpriced. The process of purchasing healthcare services can be frustrating and backward, especially when compared to the process of purchasing services for which functioning markets exist. For example, rather than receiving a final bill once care has been received, bills and notices from insurers dribble in long after medical treatment is completed. Further, far from knowing in advance how much they will pay for complex healthcare services, most patients have trouble determining how much and for what services they paid. Market failure in the healthcare industry has contributed to the chronic mismatch of capacity and utilization. For example, some healthcare providers give significant discounts to third party payers in return for patient volume. However, by and large the volume has never materialized. Thus, the efficiencies associated with “mass-production” type healthcare services have never been realized.

Another difficulty of the present healthcare industry is that consumers and even referring physicians lack sufficient knowledge of the quality and price of significant medical procedures and treatments. As a result, there is no way to properly value and price medical services. In addition, paying a higher price for a healthcare service does not yield better results, as is generally the case in the market for other services. Because there is no viable marketplace, especially for complex healthcare services, it is argued that increased government regulation is required in order to provide adequate healthcare services to the U.S. population. Yet, many feel that government regulation will not improve the provision of healthcare services to patients.

Accordingly, there have been some attempts to create or repair free markets for healthcare services. For example, an electronic exchange for cosmetic surgery has been developed. The exchange service allows prospective cosmetic surgery patients to place proposals on a Web site for cosmetic procedures. Physicians subscribing to the service then reply to the proposals with bids. The prospective patient may then choose the bid that meets his or her requirements. Another attempt to improve the marketplace for medical procedures involves the posting of prices by providers of office visits and other outpatient procedures on an Internet site. The system is designed to allow consumers the opportunity to counter bid on the available services.

While the electronic bidding systems noted above allow consumers to shop for medical procedures, they do not provide a complete marketplace for healthcare services. In particular, available systems fail to provide adequate information regarding the expertise, track record, training, experience, and clinical quality indicators for the physicians who will perform the procedure and the facility in which the procedure will be performed. In addition, present electronic bidding systems do not incorporate mechanisms to assess and provide for key patient needs such as scheduling, geography, religious needs, accommodations for family and friends, travel arrangements, and other auxiliary services.

### SUMMARY OF THE INVENTION

Accordingly, there is a need to provide a fully operative marketplace for schedulable medical procedures that allows patients to purchase medical services based on a complete price and clinical information that reflects the quality and competitiveness of healthcare service providers.

The invention provides a method of selling healthcare services to a patient. The method includes establishing a plurality of contracting healthcare service providers. The healthcare service providers respond to patient case statements with proposals for providing healthcare services requested in the case statement. A prospective patient is provided with a case statement template having one or more areas to specify clinical and non-clinical requirements of the patient. The patient then uses the template to submit case statement information to a marketplace operator. In many instances, the patient's primary physician assists the patient with completing the case statement template. The case statement information is processed by the marketplace operator. The marketplace operator prepares a case statement from the case statement information. The case statement is distributed to the contracting healthcare service providers. Interested healthcare providers then prepare a proposal or response to the case statement. The responses received form the healthcare service providers are then delivered to the prospective patient. The prospective patient reviews the responses from healthcare providers that have chosen to respond to the patient's case statement. If the patient desires to secure the services of one of the contracting service providers, the patient submits a deposit. Preferably, the deposit is sent to the marketplace operator who extracts a fee from the deposit. The remaining amount is delivered to the service provider.

The invention also provides a system of selling healthcare services. The system includes a database of contracting healthcare service providers, a healthcare case statement information submission mechanism including areas for a patient's clinical and non-clinical requirements, a case statement distribution engine to distribute or deliver case statements to healthcare service providers, and a response-receiving engine to receive response proposals from healthcare service providers and to deliver the responses to the patient.

As is apparent from the above, it is an advantage of the present invention to provide a method and system of selling healthcare services. Other features and advantages of the present invention will become apparent by consideration of the detailed description and accompanying drawings.

### BRIEF DESCRIPTION OF THE DRAWINGS

FIG. 1 is a schematic diagram of a system of the invention.

FIG. 2 is an introductory page from a content site of the invention.

FIG. 3 is a definitions page from a content site of the invention.

FIG. 4 is an explanatory page for referring physicians from a content site of the invention.

FIG. 5 is an explanatory page for contracting healthcare service providers from a content site of the invention.

FIG. 6 is another explanatory page for contracting healthcare service providers from a content site of the invention.

FIG. 7 is a general contact page of the invention.

FIG. 8 is an information request page for consumers from a content site of the invention.

FIG. 9 is an information request page for physicians from a content site of the invention.

FIG. 10 is a clinical qualifications page of the invention.

FIG. 11 is a price page of the invention.

FIG. 12 is part of a case statement template page of the invention.

FIG. 13 is another part of a case statement template page of the invention.

FIG. 14 is a referring physician information page of the invention.

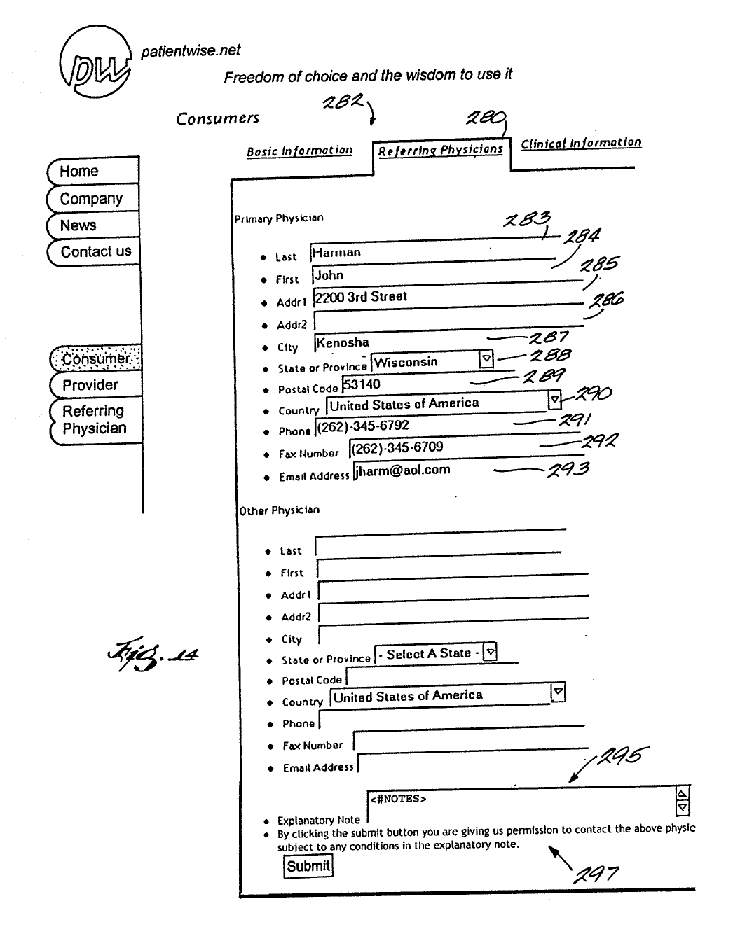

FIG. 15 is a consumer preferred services page of the invention.

FIG. 16 is a pre-registration page of the invention.

FIG. 17 is a provider profile page of the invention.

FIG. 18 is a proposal template page of the invention.

FIG. 19 is a case profile page of the invention.

FIG. 20 is a provider pending case page of the invention.

FIG. 21 is a healthcare provider status page of the invention.

FIG. 22 is a proposal review page of the invention.

FIG. 23 is a first part of a proposal comparison page of the invention.

FIG. 23A is a second part of a proposal comparison page of the invention.

### DETAILED DESCRIPTION

Before one embodiment of the invention is explained in detail, it is to be understood that the invention is not limited in its application to the details of the construction and the arrangements of the components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

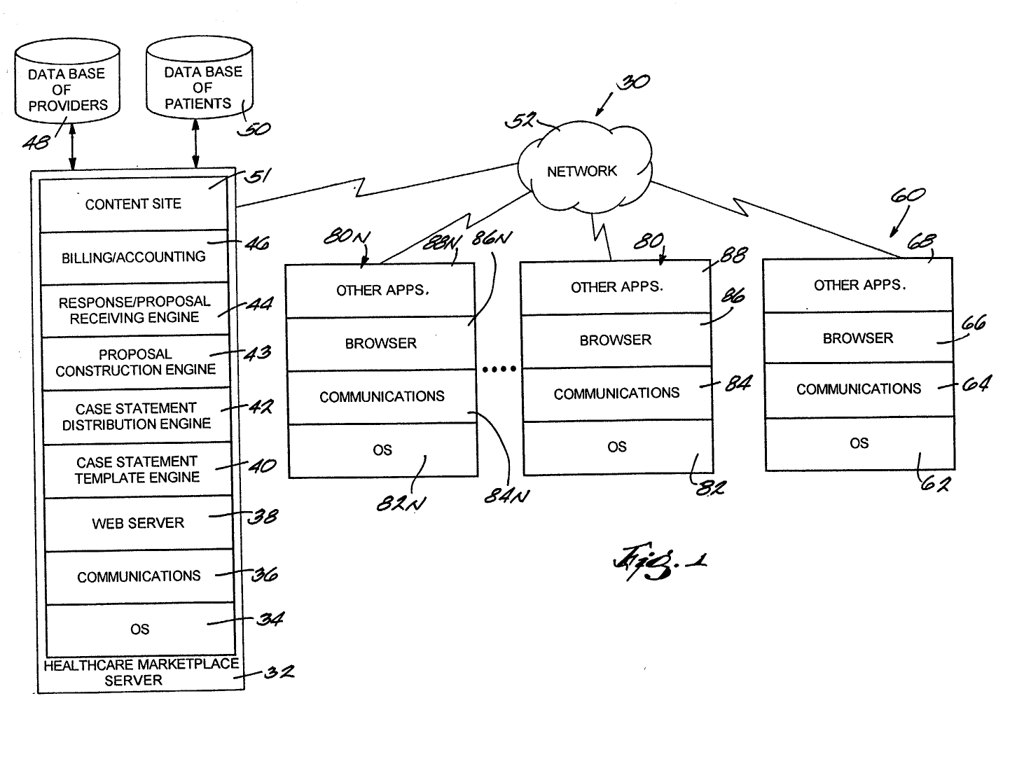

A system 30 of the invention is shown in FIG. 1. The system 30 includes a healthcare marketplace server 32 that may be operated by a marketplace facilitator or operator. The marketplace's purpose is to provide a spot marketplace for healthcare service providers. As is the case with marketplaces such as a stock exchange, the healthcare marketplace operator receives a fee for operating the market. Preferably, a small transaction fee is paid by consumers or patients who access the market. If the patient then decides to secure the services of a healthcare provider, he or see submits a deposit to secure the services of the chosen provider. The chosen healthcare service provider then pays a market fee to the marketplace operator. The market fee may be collected by requiring patient deposits to be submitted to the marketplace operator. The marketplace operator then subtracts a fee from the deposit and transfers the remaining amount to the healthcare service provider. Of course, a myriad of other methods, such as a percentage fee or a subscription fee, could be used by the marketplace operator to obtain revenues. No matter the method used, the collection and management of transaction fees, market fees, and deposits is handled by a billing module (discussed below) in the server 32.

The marketplace server 32 includes an operating system 34, a communication module 36, a Web or content server 38, a case statement template engine 40, a case statement distribution engine 42, a proposal construction engine 43, a response or proposal receiving engine 44, and a billing module 46. The case statement/template engine 38 receives information from case statement templates completed by patients and, as discussed further below, prepares case statements from the case statement information by, among other things, removing unique personal identifying information. The case statement distribution engine 42 distributes the case statements to contracting providers. The proposal construction engine 43 controls templates used by providers to create proposals and reviews the proposals to ensure that they are complete, and include price information. The proposal receiving engine 44 manages the proposals made by providers and provides tools for patients to review the proposals. The billing module 46 manages accounts and billing matters, as was discussed above.

Information used by the server 32 is stored in two databases: a database of providers 48 and a database of patients 50. Information used by the server is also stored in a content site 51 that is accessed by the Web server 38. The healthcare marketplace server 32 communicates with a number of other devices (discussed below) through a network 52. The network 52 may be a packet-switched network or a circuit-switched network, but is preferably a network based on TCP/IP or similar protocols. A network suitable for use in the invention is the Internet.

The marketplace server 32 receives information from and sends information to a patient terminal 60. The patient terminal 60 includes an operating system 62, a communications module 64, a browser 66, and other optional applications 68 that are not significant for purposes of the invention. Although only one patient terminal is shown in FIG. 1, the marketplace server 32 may communicate with a large number of identical or similar patient terminals. The number of patient terminals is limited only by the capacity of the marketplace server 32 and the network 52.

The marketplace server 32 also receives information from and sends information to a number of healthcare provider terminals 80. Each healthcare terminal 80 includes an operating system 82, a communications module 84, a browser 86, and other optional applications 88 (also not significant for purposes of the invention). The number of healthcare provider terminals that the marketplace server 32 may communicate with is limited only by the capacity of the marketplace server 32 and the network 52.

Having described the basic architecture of the system 30, its operation will now be explained. The marketplace server 32 has a variety of tools and information that are accessible to users of the system 30. The users of the system include patients, referring physicians, healthcare providers, and physicians from participating healthcare providers. The content site 51 of marketplace server 32 includes formatted content, such as HTML pages, that is distributed by the Web server 38. Preferably, the content on the content site 51 is configured as a Web site and accessible by any terminal 60 or 80 connected to the network 52.

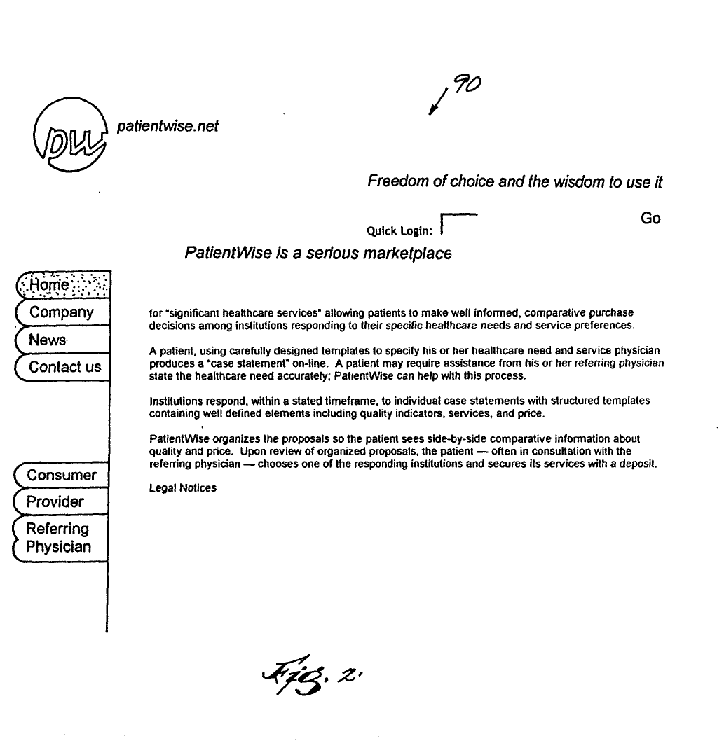

As can be seen by reference to FIG. 2, the content site 51 includes an introductory page 90 that explains the basic premise of the system 30. As noted on page 90, the system 30 provides a marketplace for healthcare services, particularly significant and schedulable services such as back surgery, cardiac surgery, and other non-emergency procedures. As will be discussed in greater detail below, a prospective patient uses a template to specify his or her healthcare needs and requirements for associated amenities and services (such as needs for a private room, transportation, nutrition, time and date of the procedure, and the like). The information entered in the template is used to create a case statement. The case statement is then forwarded to healthcare service providers who may choose to prepare a proposal response to the case statement of the patient. The patient then reviews the responses and may choose to contract for the services desired from one of the responding healthcare service providers. Generally, the services are secured with a deposit sent to the service provider. A portion of this deposit is paid to the operator of the marketplace server as a fee for providing the market. The system 30 provides a spot marketplace, meaning that the price quoted by a participating healthcare service provider applies to a single, specific case statement for a particular patient and no other. In general, the system 30 is configured such that prices are made available only to patients who have requested proposals from healthcare providers.

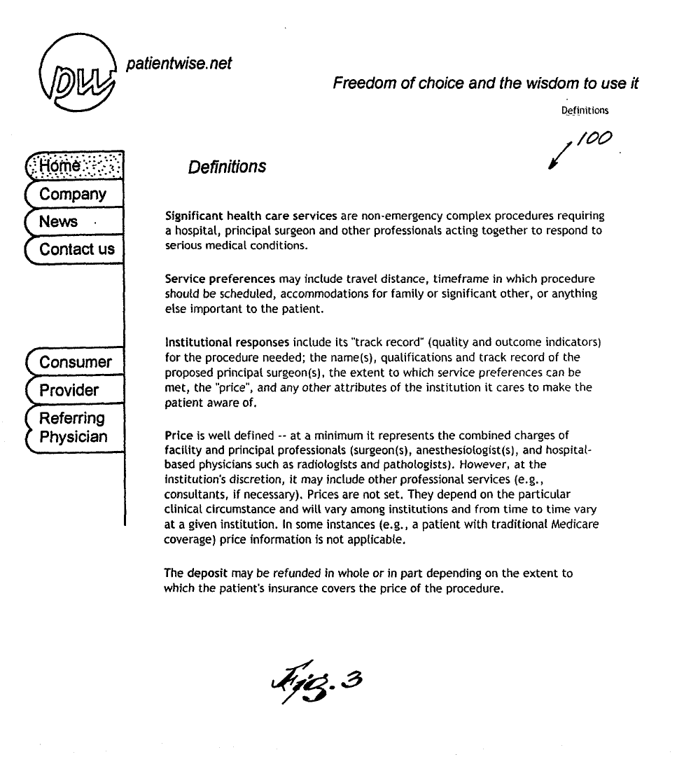

FIG. 3 illustrates a page 100 that lists a number of definitions for operational terms used in the marketplace created with the system 30. The definitions relate to terms used in one embodiment of the invention. For example, the term “significant healthcare services” is defined as non-emergency, complex procedures requiring a hospital, principal surgeon, and other medical professionals acting together to respond to a medical condition. The term “service preferences” is defined to include those preferences or requirements of a patient related to travel distance, the timeframe within which the procedure should be scheduled, the names or qualifications and track record of the principal surgeons, the extent to which the services must meet the patient preferences, the price of the services, and any other attributes of the institute or services that the patient desires. “Institutional responses” are defined as responses that include the quality and outcome indicators of the procedure needed by the patient; the names, qualifications, and track record of the proposed principle physicians; the extent to which the requirements of the patient can be met by the institution; the price of the services; and any other attributes that the healthcare provider wishes the patient to be aware of. For purposes of the present invention, “price” is defined as the combined charges of the facility and principal professionals (including surgeons, anesthesiologists, and hospital-based physicians such as radiologists and pathologists). The price may also include other professional services (for example, consultants, if necessary). Prices are not set, but depend on the particular clinical circumstances of a patient and vary among healthcare providers. In some instances, price information will not be provided or will otherwise not be applicable. For example, price information is not provided in responses made to patients with traditional Medicare coverage. The “deposit” is an amount used by the healthcare provider to ensure that the patient will uphold his or her obligation to purchase healthcare services from the healthcare provider. The deposit may be refunded in whole or in part depending on the extent to which the patient's insurance covers the price of the medical procedure. Of course, the invention could be implemented in embodiments that fall outside the definitions of the noted terms. For example, the invention could be extended to cover “less-significant” healthcare services, such as dentistry, elective surgery, and the like.

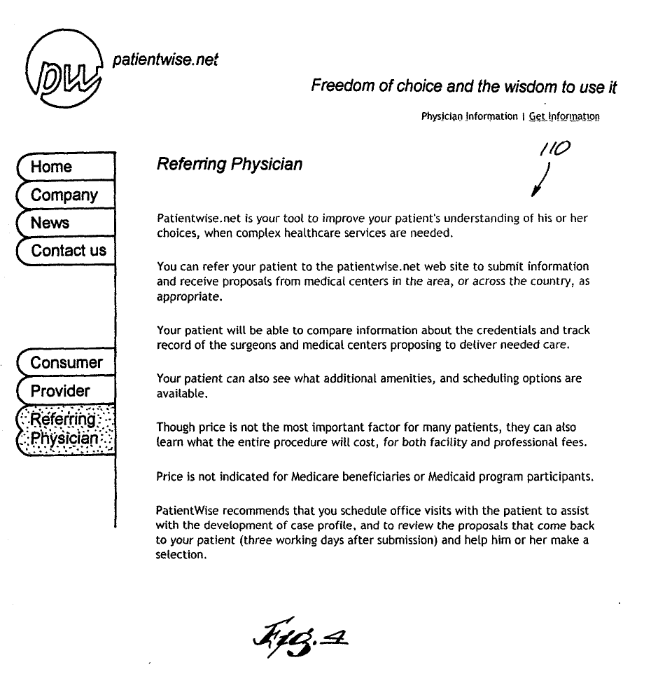

To entice patients and physicians to use and to make them feel comfortable with the system, additional explanatory pages are included in the content site 51. FIG. 4 illustrates a referring physician page 110. The page 110 includes an explanation summarizing the role of a referring physician in the marketplace created with the system 30. The page 110 explains that a referring physician can refer his or her patient to the content and tools on the marketplace server 32 to submit information and receive responses from medical centers in a geographic area chosen by the patient. The page 110 further explains that the patient is able to compare information about the credentials and track record of the surgeons and medical centers proposing to deliver the needed care.

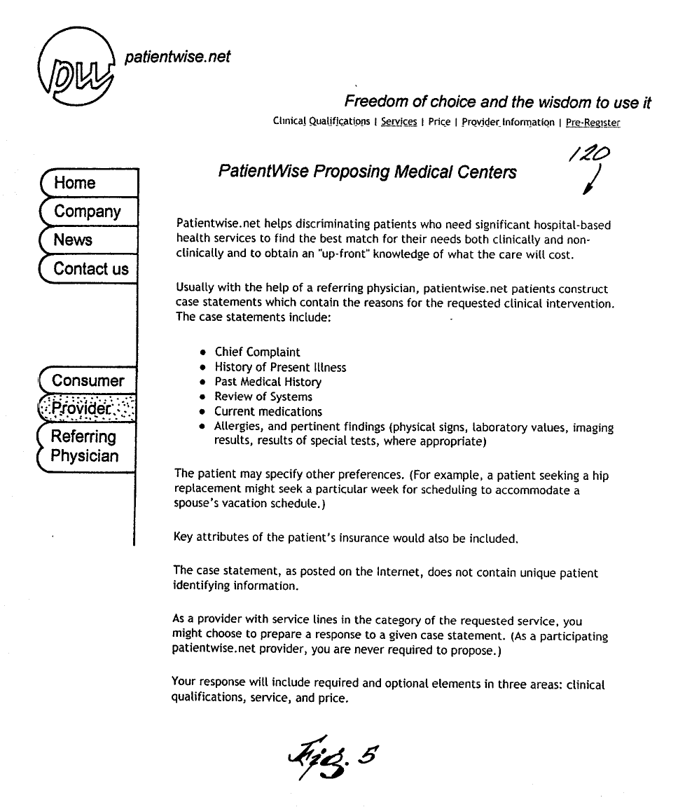

FIG. 5 illustrates a healthcare provider page 120. The page 120 provides a brief explanation to prospective healthcare service providers regarding the operation of the system 30. The page 120 explains that the healthcare provider receives case statements containing the reasons for the requested medical care and that each case statement includes a description of the chief complaint, the history of the present illness, the past medical history of the patient, a review of systems (which, as is known in the art, refers to a head-to-toe review of bodily functions), the current medications of the patient, allergies, and other pertinent findings (such as physical signs, laboratory values, imaging results, and results of special tests). The page 120 also explains that the patient may specify other preferences such as the date and time that he or she wishes to have the procedure performed and other preferences and amenities desired by the patient. Lastly, the page 120 indicates that the healthcare service provider will provide a response that includes clinical qualifications, available services, and price.

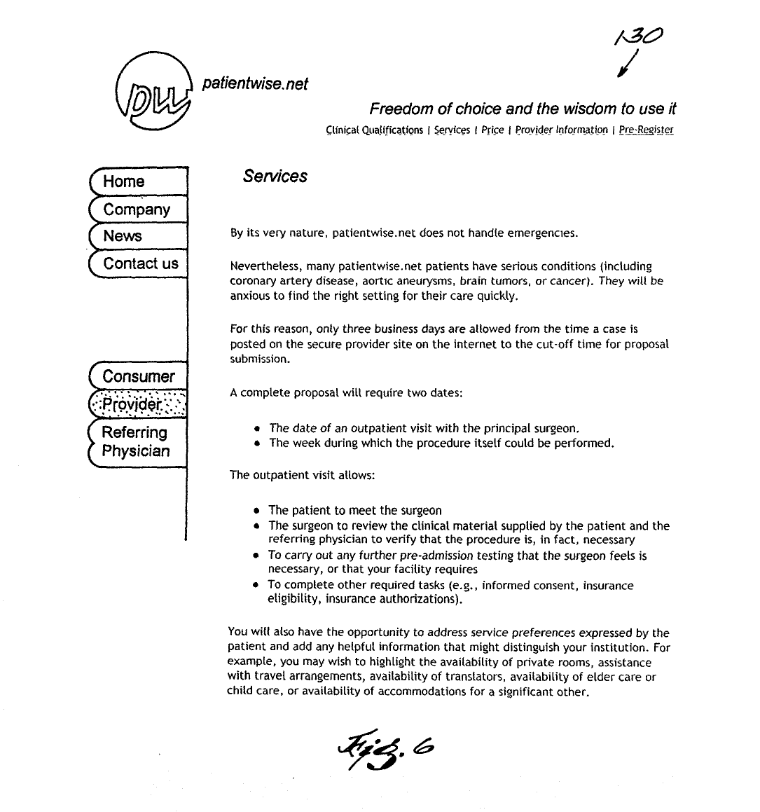

FIG. 6 illustrates a services page 130. The services page 130 indicates that the marketplace created using the system 30 is not designed to handle emergency medical situations. Nevertheless, since patients are generally requesting surgical procedures, the page 130 indicates that patients may have serious conditions such as coronary artery disease, aortic aneurysms, brain tumors, or cancer. In view of this fact, the system is preferably designed with a response time limitation to ensure that healthcare providers promptly respond to the case statements submitted to them. In one embodiment of the invention, healthcare providers are allowed three business days to respond to case statement proposals submitted by patients. The page 130 instructs prospective healthcare service providers that a complete response requires two dates: a date of an outpatient visit with the principal surgeon and the week during which the procedure itself could be performed. As envisioned by the inventors, the outpatient visit provides an opportunity for 1) the patient to meet the surgeon, 2) the surgeon to review the clinical material supplied by the patient and the referring physician in order to verify that the procedure is necessary, 3) the surgeon or his or her medical staff to carry out any further preadmission testing that the surgeon feels is necessary or that his or her facility requires, and 4) the surgeon or his or her associated medical staff to complete any other required tasks such as obtaining informed consent, checking insurance eligibility, and obtaining insurance authorizations. The page 130 also explains that healthcare service providers can include in their response proposal any other information that may be used to distinguish their institution from potential competitors. For example, distinguishing information might include the availability of private rooms, assistance for travel arrangements, the availability of translators, the availability of eldercare or childcare, or the availability of accommodations for family and friends.

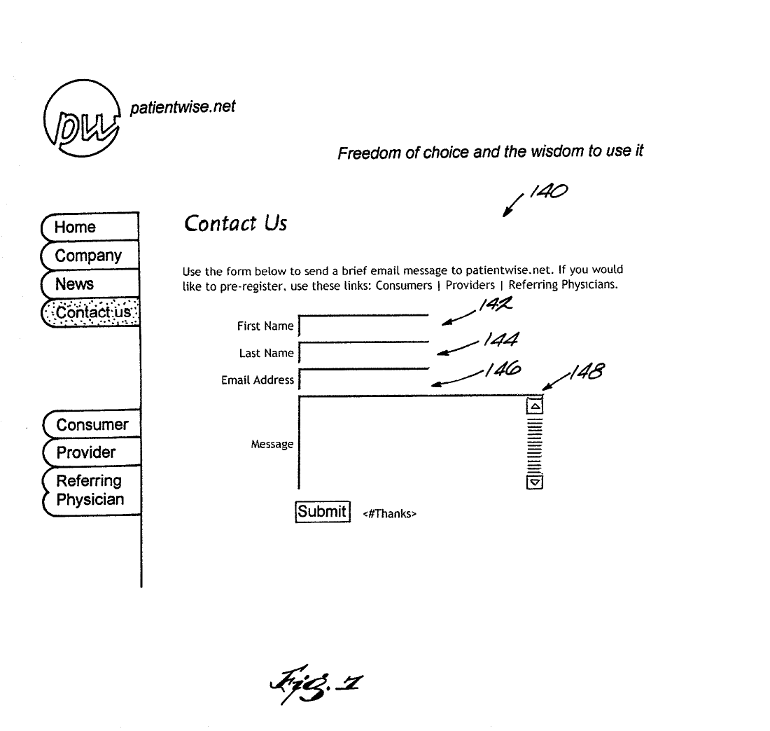

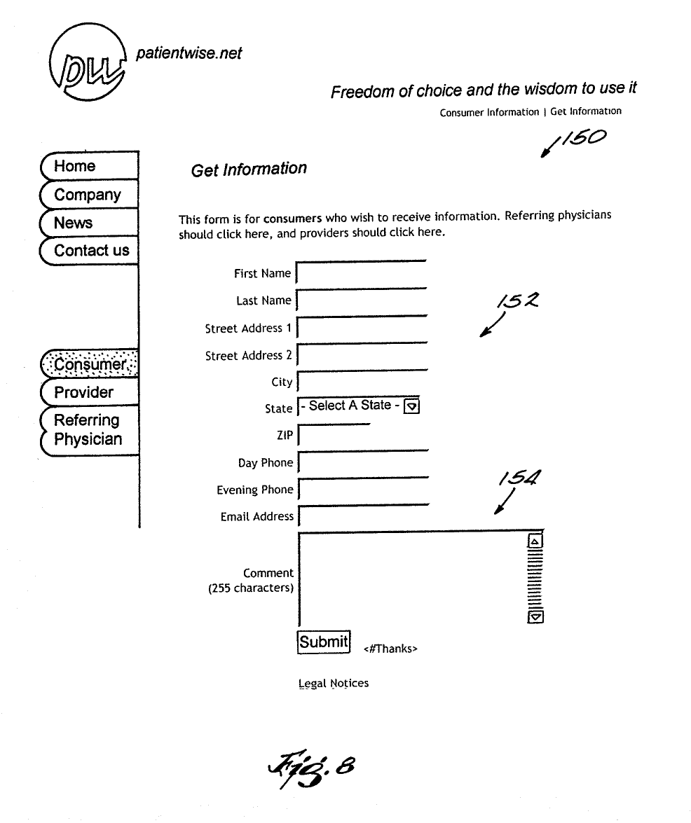

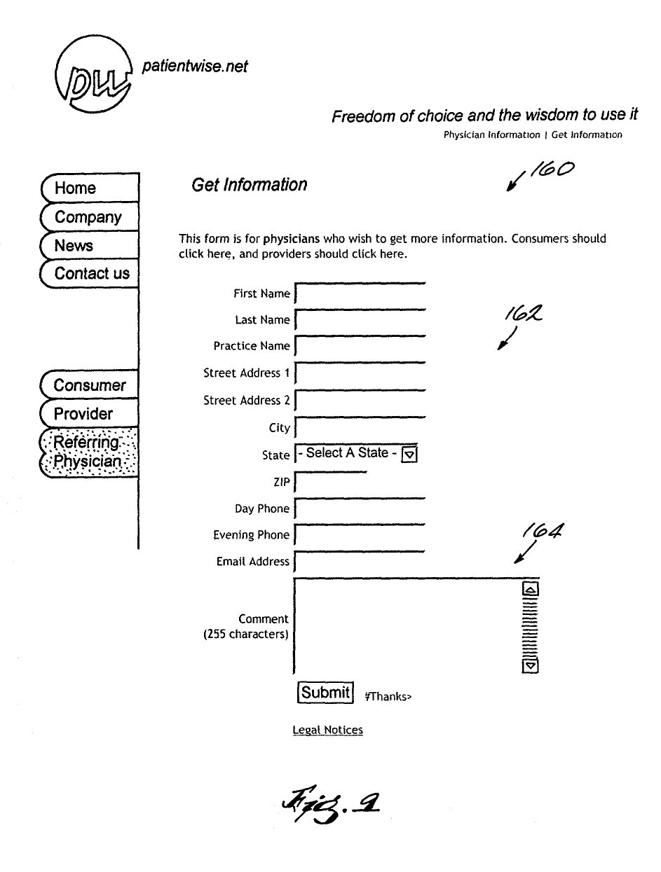

FIG. 7 illustrates a contact page 140. After reviewing the pages 90, 100, 110, 120, and 130, a visitor to the site hosted on the marketplace server 32 can obtain additional information or ask questions of the healthcare marketplace operator by sending a message to the server 32. The message is constructed using contact dialog boxes 142, 144, 146, and 148. The site 51 provides two additional mechanisms by which consumers and physicians may obtain additional information regarding the marketplace. FIG. 8 illustrates an information page 150 that provides a template 152 and comment box 154. By completing the template and writing a question or comment in the comment box 154 a prospective patient or consumer may request additional information from the marketplace operator. FIG. 9 illustrates a similar page 160 with a template 162 and a comment box 164. By completing the template 162 and box 164 a physician interested in participating in the market created by the system 30 may request additional information from the marketplace operator.

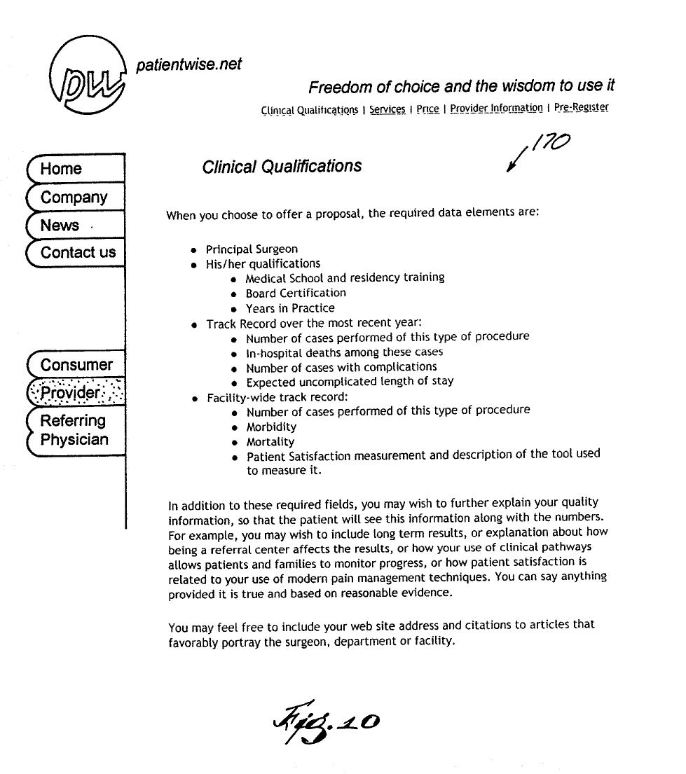

FIG. 10 illustrates a clinical qualifications page 170. The page 170 provides a summary of the data elements required in the response proposals made by healthcare providers. The required data elements in the response include the name of the principal surgeon, his or her qualifications including the medical school attended and residency training received, board certification, and years in practice. In addition, a response proposal must include the track record for the principal surgeon including the number of cases performed for the type of procedure at issue, the number of in-hospital deaths among these cases, the number of cases with complications, and the expected length of stay for a procedure in which no complications occur. Other required data elements include measurements of the healthcare service provider's track record, including the number of cases performed on the type of procedure at issue, the morbidity rate, the mortality rate, and patient satisfaction measurements including the tools used to make those measurements. In addition to the required data elements, service providers may submit additional information explaining the raw data provided. Additional information such as long-term results, explanations about how being a referral center affects the results, how the healthcare service provider's use of clinical pathways allows patients and families to monitor progress, or how patient satisfaction is related to the healthcare service provider's use of modern pain management techniques. It is envisioned by the inventors that the healthcare service provider may include any other information including Web site addresses and citations to articles concerning the principal surgeon or the healthcare provider itself, so long as the additional information is true and based on a reasonable evidence.

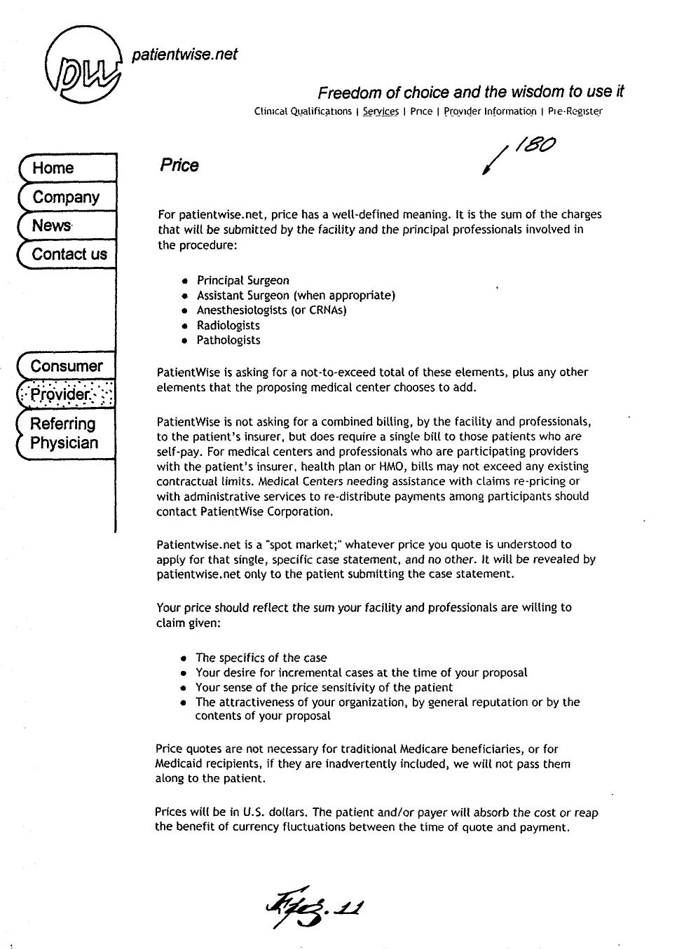

FIG. 11 illustrates a price page 180. The price page 180 describes the costs that are to be included and the price listed in a healthcare service provider's response proposal. In one embodiment of the invention, the price includes the sum of charges submitted by the facility and the principal professionals involved in the subject procedure. The professionals involved in the procedure include the principal surgeon, the assistant surgeon (when necessary), the anesthesiologist, the radiologist, and any other required specialists. The price is a not-to-exceed total of these elements plus any other elements that the proposing healthcare provider chooses to add. Except in those cases where patients are self-funded, combined billing is not required. That is, except for patients that are paying cash or an equivalent to cash, multiple bills totaling the not to exceed amount may be issued rather than one single bill. Healthcare service providers are encouraged to provide a price based on the specifics of the case, the healthcare service providers desire for incremental cases, the price sensitivity of the subject patient, and the attractiveness of the healthcare service provider based on such factors as reputation, expertise, locale, are other pertinent considerations. Because many patients using the system 30 are likely, at least in the initial stages, to reside outside of the United States, the system 30 is configured such that the price is to be quoted in U.S. dollars and that the price will not be changed due to currency fluctuations between the time of the quotation and the time of payment by the patient.

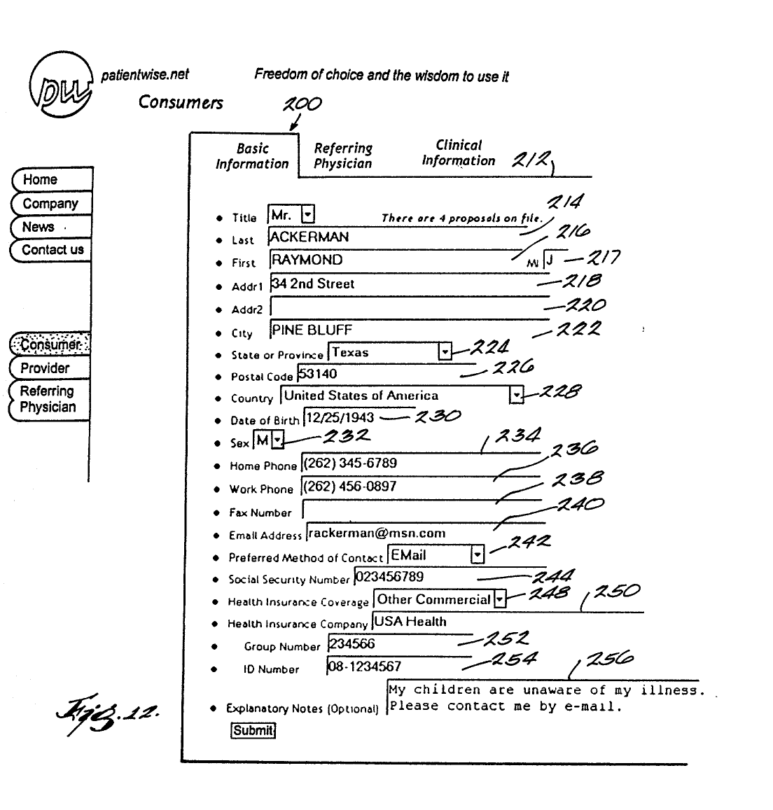

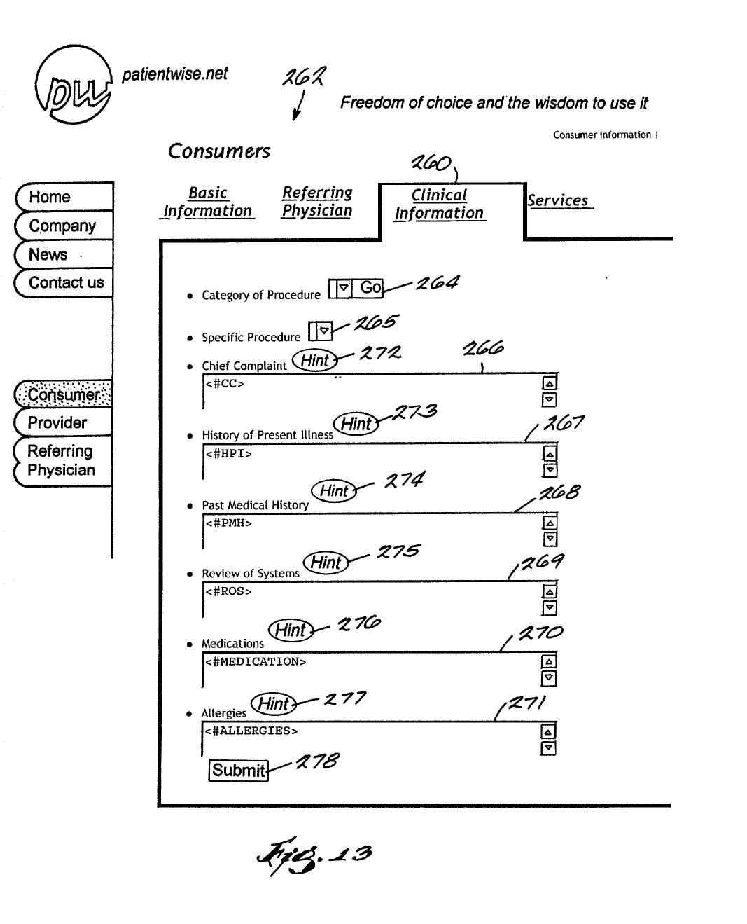

FIG. 12 shows a patient basic information page 200 having a case statement template 212 with a number of input boxes 214 through 254 that provide areas for a patient to enter his or her name, address, data of birth, sex, contact information, Social Security number, health insurance coverage, and health insurance company. In addition, a dialog box 256 is provided to permit a patient to enter explanatory notes. Once the patient's basic information is entered into the template 212, the patient may provide the system 30 with clinical information by completing and submitting a clinical information template 260 on a page 262, as shown in FIG. 13. The template 260 includes dialog boxes 264 through 271 for entering information concerning the 1) category of procedure, 2) specific procedure, 3) patient's chief complaint, 4) history of present illness, 4) past medical history, 5) review of systems, 6) medications taken by the patient, and allergies of the patient, respectively. The dialog boxes 266 through 271 include hint buttons 272 through 277. Each hint box provides examples of the type of information that should be included in each of the dialog boxes. Once the template 260 is completed a patient may send the information to the marketplace server 32 by selecting a submit button 278.

Along with information concerning the patient and his or her medical condition, information concerning the patient's referring physician or physicians is submitted to the marketplace server 32 using a template 280 on a referring physician's page 282. The template 280 includes name and address information dialog boxes 283 through 293 regarding information for a primary physician. The template 280 may include similar dialog boxes (not numbered) for another physician such as an allergist, cardiologist, or other specialist. The template 280 may also include an explanatory notes box 295 in which a patient may provide additional details concerning the referring physicians. The template 280 also includes a warning notice 297 informing the patient that by submitting the information he or she is granting the marketplace operator permission to contact the physicians entered in the template 280.

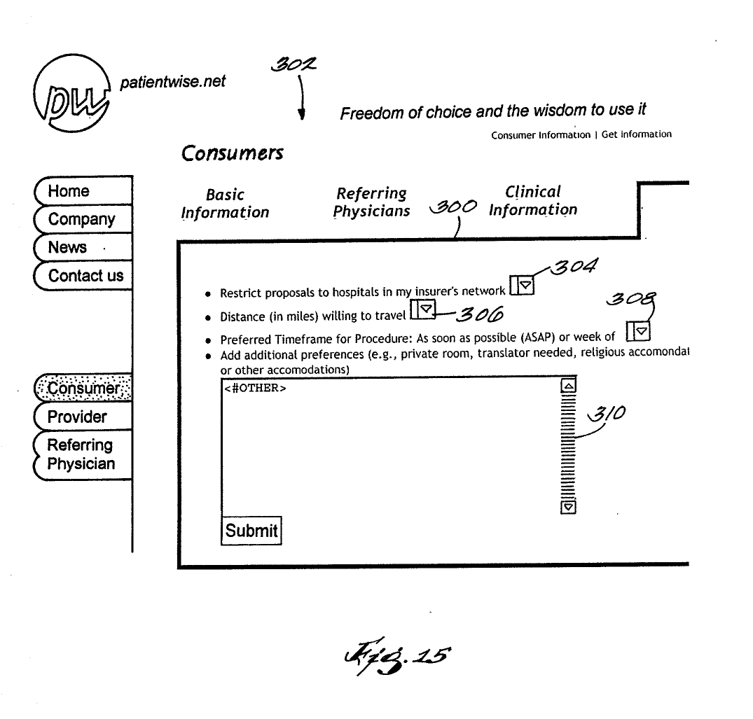

In addition to personal and referring physician information, a patient's case statement includes other service information that is gathered by the invention through a service's template 300 on services page 302 (FIG.15). The services template includes a dialog box 304 that provides a mechanism for a patient to restrict response proposals to hospitals in his or her insurer's network. The template 300 also includes a dialog box 306 that provides a mechanism for a patient to restrict response proposals to healthcare service providers within a certain geographical distance. The template 300 also includes a dialog box 308 which provides a patient a mechanism to indicate a preferred time frame for completing the procedure and a dialog box 310 in which a patient may list additional preferences, such as a desire for a private room, the need for a translator, religious affiliation, accommodation needs for friends and relatives, a need for assistance with travel arrangements, and other requirements. The information provided by a patient is submitted to the server 32. A case statement is generated from that information and provided to contracting healthcare providers. The case statement includes the information from the case statement templates except for unique identifying information such as a patient's Social Security number.

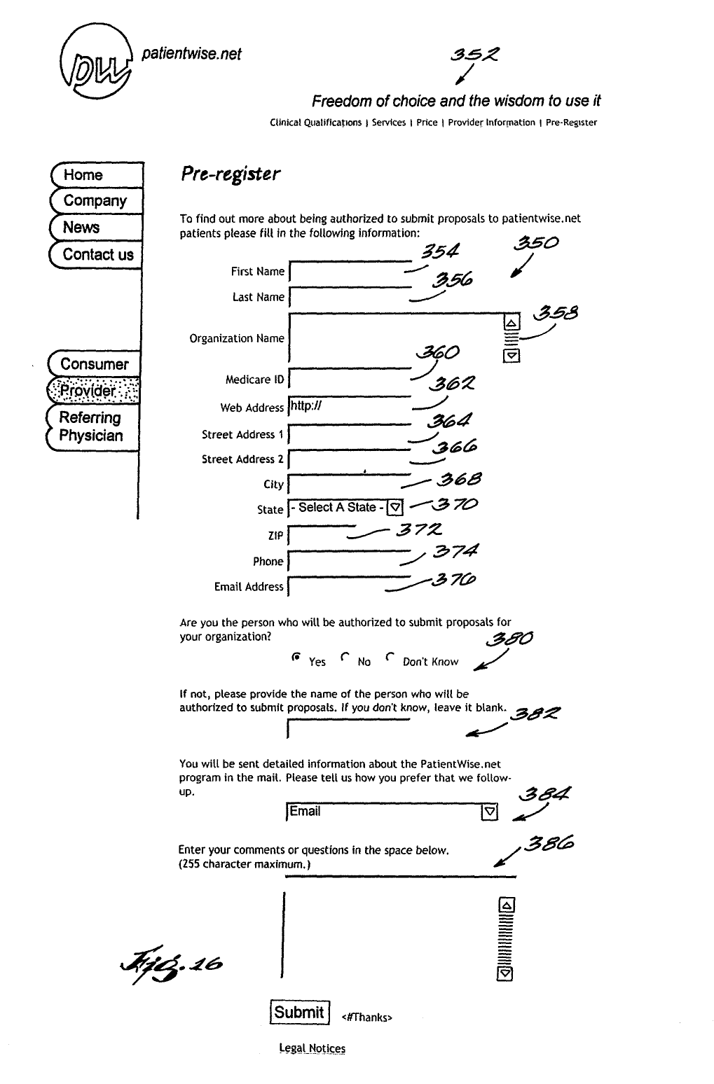

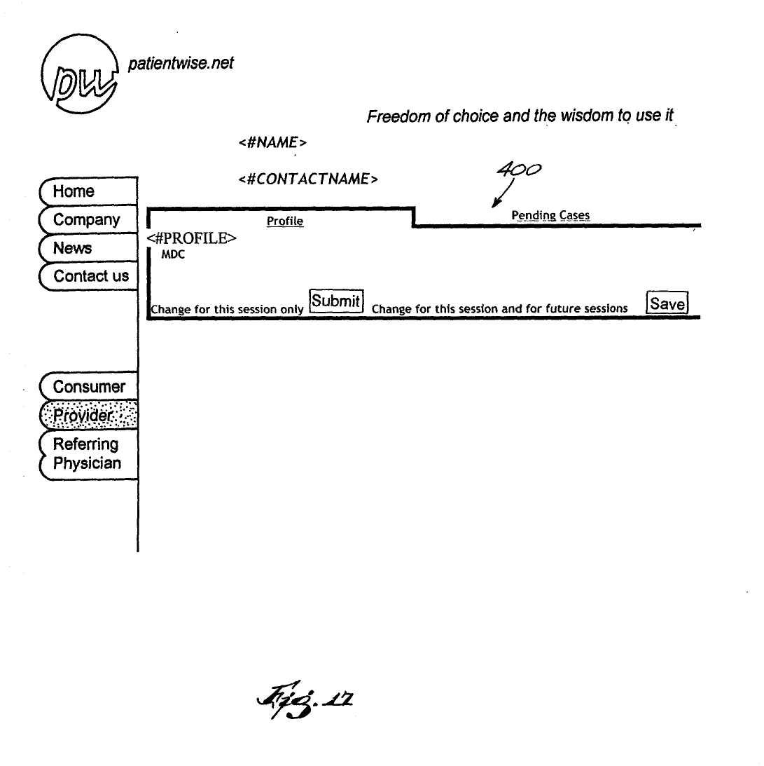

Before a healthcare service provider can participate in the marketplace and receive case statements, that healthcare service provider must pre-register with the marketplace. The system 30 includes a pre-registration mechanism for perspective healthcare service providers. As shown in FIG. 16, interested service providers may complete a pre-register template 350 on a page 352. The template 350 includes contact name, organization name, Medicare ID, Web address, street address, and e-mail address information input boxes 354 through 376. In addition, the template 350 includes additional input mechanisms 380 through 386 concerning the person who will submit response proposals from the healthcare service provider to the healthcare marketplace, the manner in which the healthcare service provider prefers to receive information from the marketplace operator, and additional comments that the service provider may wish to include in its pre-registration application. FIG. 17 includes a template 400 whereby a service provider may change the designated contact person for that provider.

After the healthcare operator of the marketplace server 32 has received the pre-registration information from the perspective healthcare service provider, information regarding the healthcare service provider is stored in the database 48. As case statement information is submitted by patients to the marketplace server 32, the case statement engine creates a case statement, distributes the case statement to contracting healthcare providers, and creates a record of the patient, which is stored in the database 50. Should a healthcare service provider that receives a case statement from the case statement engine 42 choose to prepare a response proposal, the service provider must submit information concerning the surgeon to perform the subject procedure and the facility in which the procedure will be performed.

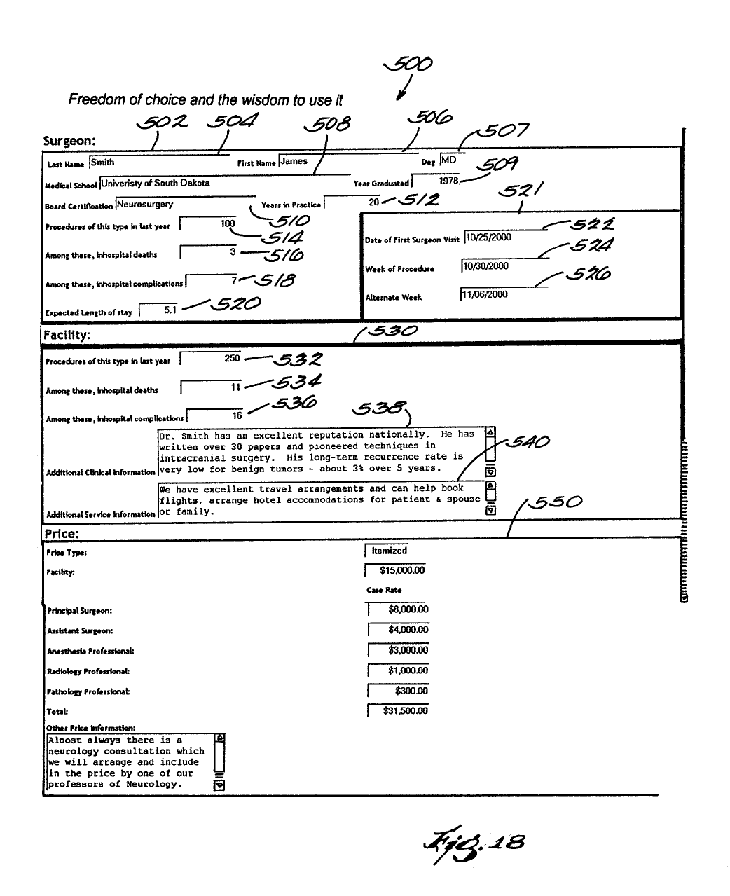

FIG. 18 illustrates a proposal template page 500 that interacts with the proposal construction engine 43. The page 500 is used by a responding healthcare service provider to create a proposal. The page 500 includes a surgeon template 502. The surgeon template 502 includes dialog boxes 504 through 520. The dialog boxes 504 through 520 provide input mechanisms for the surgeon's first and last name, degree, medical school, year of graduation, board certification, years in practice, procedures of this type performed in the last year, the number of in-hospital deaths for these types of procedures, the number of in-hospital complications for these of types procedures, and the expected length of stay for a procedure in which no complications occur. The page 500 includes a sub-template 521 with dialog boxes 522 through 526. These boxes providing mechanisms for the surgeon to indicate the date of the first outpatient visit, the proposed week for the subject procedure, and an alternative week for the procedure.

In addition to the surgeon template 502, the page 500 includes a facility template 530 having dialog boxes 532, 534, 536, 538, and 540. These boxes provide input mechanisms for the healthcare service provider to indicate the number of procedures performed at its facility in the last year, the number of in-hospital or in-facility deaths that occurred for the type of procedure indicated in box 532, and the number of in-hospital complications for the subject procedures. The boxes 538 and 540 provide input mechanisms for the healthcare service provider to submit additional information regarding its clinical track record and additional information concerning available services at its facility. Lastly, page 500 includes a price dialog box 550 in which the healthcare service provider enters a price, as defined above, for the services to be performed. The price may include detailed information for the charges of each professional participating in the procedure. The response proposal is submitted to the healthcare server 32 by selecting a submit button (not shown). If necessary, the healthcare service provider may correct information submitted in the templates 502, 521, or 530 or the price dialog box 550 by selecting a reset button (also not shown).

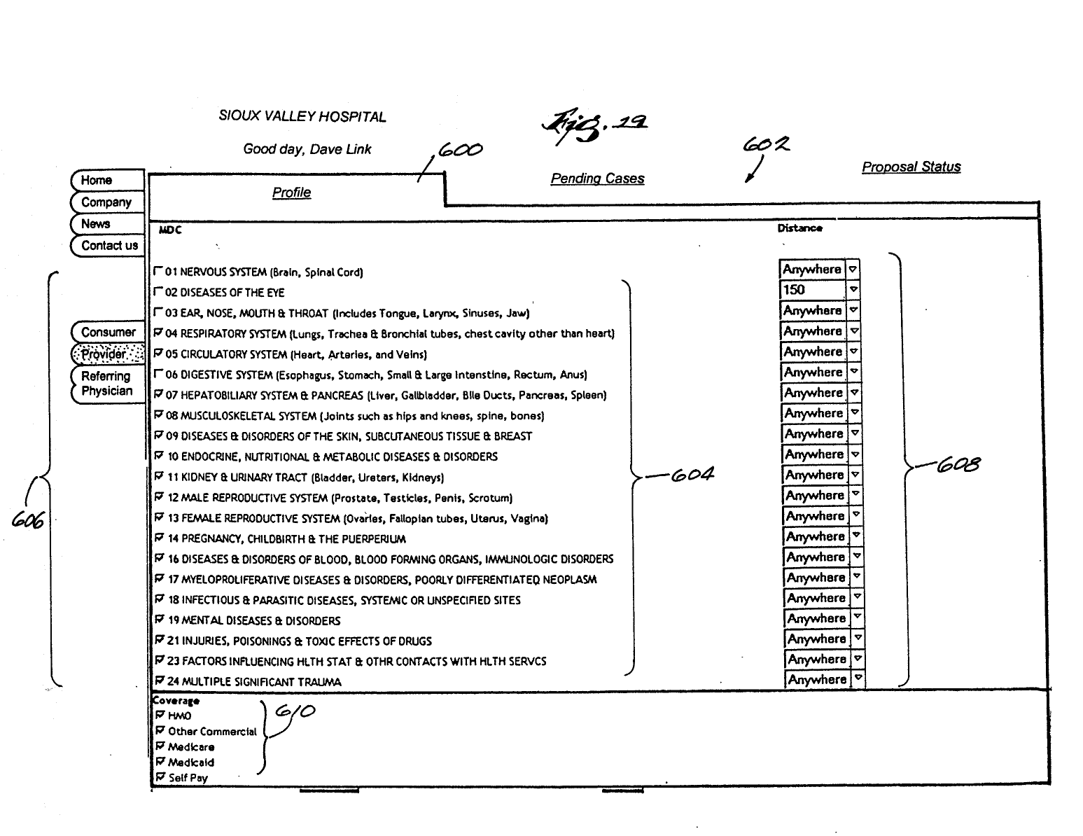

As was noted, a healthcare service provider will not respond to every case statement it receives. In most cases, a failure to respond will be based on a mismatch between the needs of the patient and the capabilities of the healthcare provider. To help ensure that the healthcare service provider receives case statements for procedures it is capable of performing and desires to perform, the invention includes a case statement filter, which is manifested to the service provider as a profile tab 600 on page 602 (FIG. 19).

The profile tab 600 includes a plurality of procedural/medical areas 604 with a plurality of associated selectors 606. If the service provider wishes to receive case statements in a procedural/medical area, the service provider selects an associated selector for that area. Each procedural/medical area 604 also includes a distance selector 608 in the form of a distance dialog box. The provider may use the distance selectors 608 to indicate whether it will limit its review of case statements to those from patients who live within a certain distance of the healthcare provider.

In addition to the limiting factors described, the healthcare provider may also limit or select case statements by the type of insurance the patient carries. In the example shown, the tab 600 includes five dialog boxes 610 to cover common insurance options: HMO, commercial insurance, Medicare, Medicaid, and self-pay.

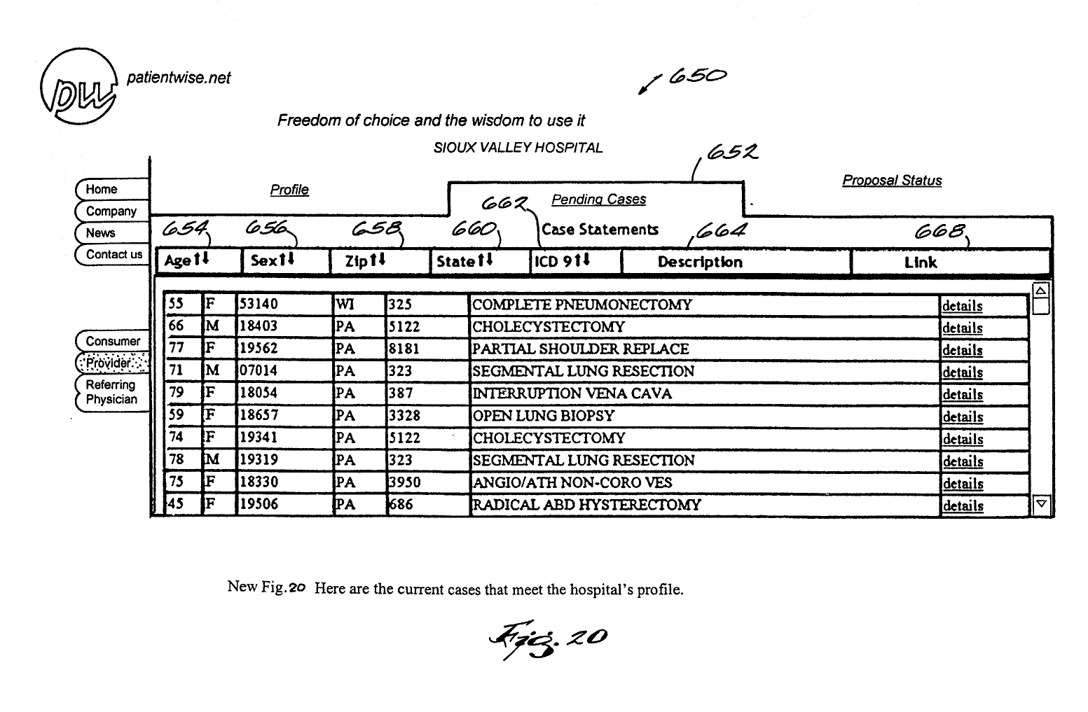

Once the profile information from the page 602 is submitted to the server 32, the proposal construction engine 43 prepares a list of case statements that meet each contracting healthcare provider's profile. The list of case statements is presented on a page 650 (FIG. 20), which is accessible to the relevant health care provider. The page 650 includes a table 652 with an age column 654, a sex column 656, a zip-code column 658, a state column 660, an ICD-9 (a World Healthcare Organization disease classification number) column 662, and a description column 664. The table 652 may also include a link column 668 that provides a link to the detailed case statement for the particular patient at issue. The healthcare provider reviews the list in the table 652 and selects those case statements it wishes to prepare proposals for.

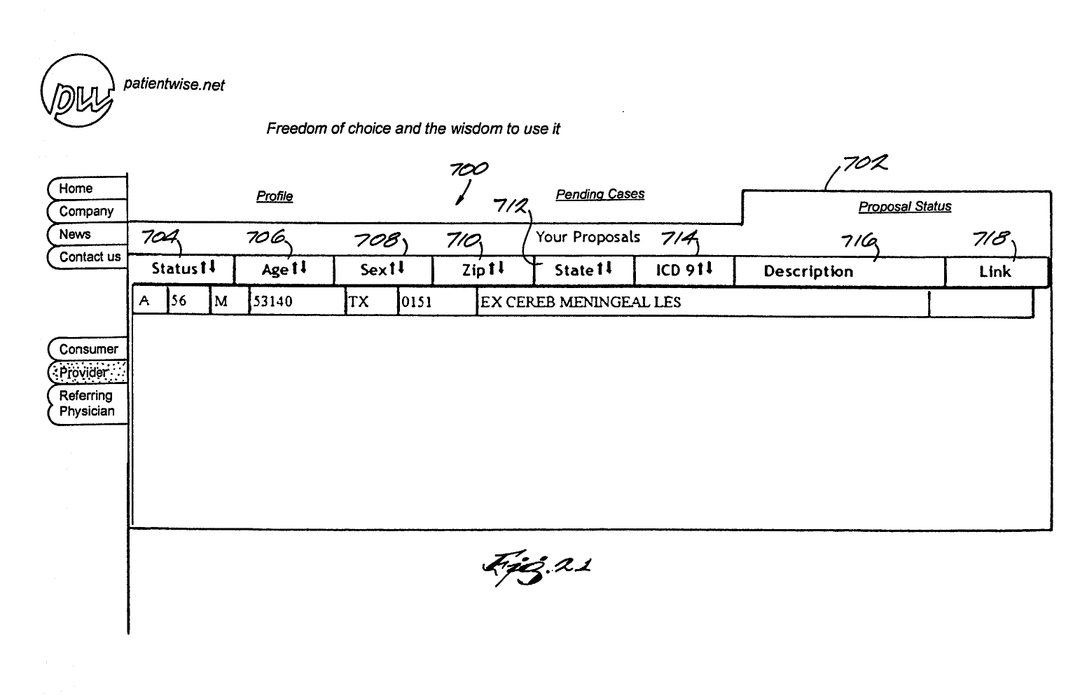

As the marketplace develops and the participation of healthcare service providers increase, each participating healthcare provider will have submitted numerous proposals. The status of the submitted proposals is tracked using a proposal status tab 700 (FIG. 21) controlled by the proposal receiving engine 44. The tab 700 includes a table 702 having a status column 704, an age column 706, a sex column 708, a zip-code column 710, a state column 712, an ICD-9 column 714, a description column 716, and a link column 718. The status column 704 includes an indication, such as an “A,” concerning whether the healthcare provider's proposal has been accepted by the patient. The remaining columns 706-718 are similar to the columns discussed with respect to the tab 652.

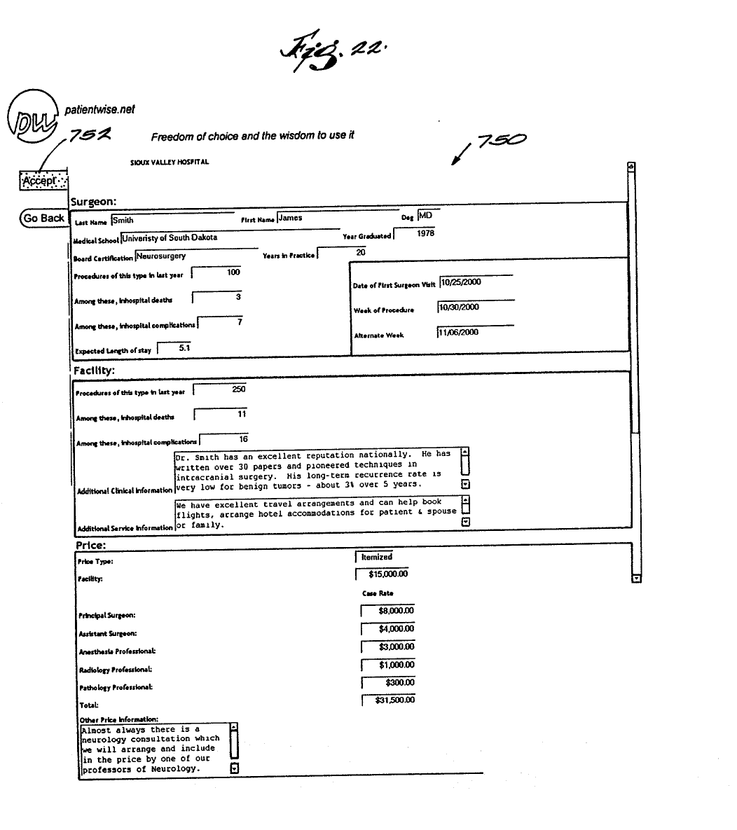

A patient may review a proposal by accessing a proposal review page 750 (FIG. 22). The proposal review page 750 includes all of the information shown in the page 500. It also includes an accept button 752 by which the patient may indicate his or her acceptance of the proposal.

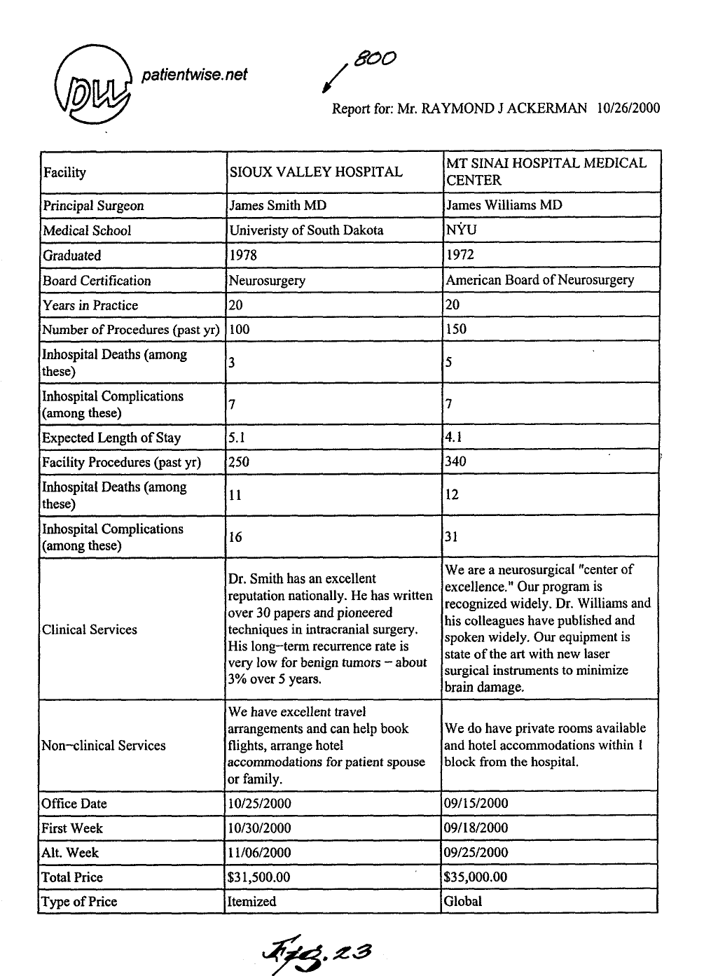

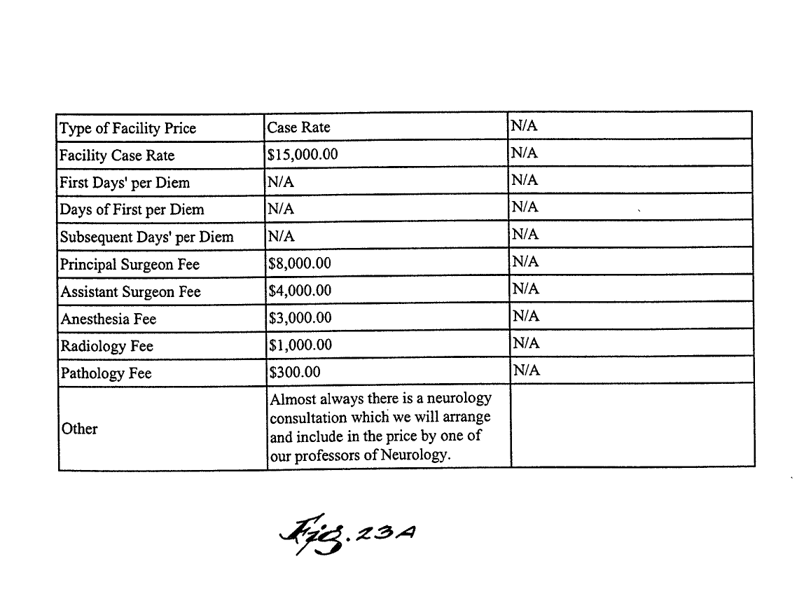

To better assist patients in making a purchasing decision; the invention provides a comparison page 800, as shown in FIGS. 23 and 23A. The comparison page includes the information from two proposals formatted in a side-by-side column display. Although not shown, additional comparison pages can be generated by the system 30, so that the patient can review numerous proposals. The patient uses the comparison pages to compare and contrast the proposals he or she receives in response to the case statement distributed to the contracting healthcare providers.

As can be seen from the above, the invention provides a method and system for selling healthcare services. The invention provides tools for patients to submit case statement information, healthcare providers to prepare proposals, and tools for patients to review and accept proposals. The invention provides the price and quality information lacking in present systems and markets for selling healthcare services. Various features and advantages of the invention are set forth in the following claims.

What is claimed is:

1. A method of selling healthcare services to a patient, the method comprising:
establishing a plurality of contracting healthcare service providers;
providing a case statement template having one or more areas to specify clinical and non-clinical requirements of the patient;
receiving case statement information, at least a portion of which is provided by the patient;
preparing a case statement based on the case statement information;
delivering the case statement to at least one contracting healthcare service provider; and
receiving a response from the at least one contracting healthcare service provider, the response including a price, a clinical track record, and service information.

2. A method as claimed in claim 1, wherein the response includes information concerning one or more clinical quality indicators for one healthcare service provider.

3. A method as claimed in claim 2, wherein the one or more clinical quality indicators includes the mortality rate for a medical procedure.

4. A method as claimed in claim 2, wherein the one or more clinical quality indicators includes the number of times a medical procedure has been performed.

5. A method as claimed in claim 2, wherein the one or more clinical quality indicators includes the number of times a medical procedure has been performed by a physician associated with one of the one or more contracting healthcare service providers.

6. A method as claimed in claim 1, further comprising reviewing the proposal from the at least one healthcare service provider.

7. A method as claimed in claim 6, wherein reviewing the proposal from the at least one healthcare service provider includes reviewing the proposal with a referring physician.

8. A method as claimed in claim 1, wherein the proposal includes information concerning the total cost of a medical procedure.

9. A method as claimed in claim 1, further comprising securing the services of a responding healthcare service provider by sending a deposit to the responding healthcare service provider.

10. A method as claimed in claim 1, further comprising securing the services of a responding healthcare service provider by sending a deposit to a marketplace operator and sending a remaining amount to the responding healthcare service provider.

11. A method as claimed in claim 1, wherein preparing a case statement from case statement information includes filtering unique identifying information.

12. A method as claimed in claim 1, further comprising scheduling an outpatient visit with the patient and a staff member of the at least one contracting healthcare service provider.

13. A method as claimed in claim 1, wherein the price is a not-to-exceed amount.

14. A method as claimed in claim 13, wherein the price includes the combined charges of a facility of the at least contracting healthcare service provider and the principal professionals performing the healthcare services.

15. A system of selling healthcare services, the system comprising:
a database of contracting healthcare service providers;
a healthcare case statement information submission mechanism including areas for a patient's clinical and non-clinical requirements;
a healthcare case statement distribution engine to deliver case statements to healthcare service providers;
a proposal construction engine including clinical quality indicator areas; and
a response-receiving engine to receive responses from healthcare service providers and to deliver the responses to the patient.

16. A system as claimed in claim 15, further comprising a database of patients.

17. A system as claimed in claim 15, wherein the response reviewing engine checks responses for clinical quality indicators.

18. A system as claimed in claim 17, wherein the clinical quality indicators include the mortality rate for a medical procedure.

19. A system as claimed in claim 17, wherein the clinical quality indicators include the number of times a medical procedure has been performed.

20. A system as claimed in claim 17, wherein the clinical quality indicators include the number of times a medical procedure has been performed by a physician associated with one particular response.

21. A system as claimed in claim 15, further comprising a referring physician template.

22. A system as claimed in claim 15, further comprising a contact mechanism including a number of input mechanisms to construct a message.

23. A system as claimed in claim 15, wherein the proposal construction engine checks responses for a price of healthcare services listed therein.

24. A system as claimed in claim 15, further comprising a billing module.

25. A system as claimed in claim 15, further comprising at least one patient terminal coupled to the case statement information submission mechanism.

26. A system as claimed in claim 15, further comprising at least one service provider terminal coupled to the healthcare case statement distribution engine.

27. A system as claimed in claim 15, wherein the healthcare case statement submission mechanism; the healthcare case statement distribution engine; the proposal construction engine; and the response-receiving engine are located on a server.

28. A method of selling healthcare services to a patient, the method comprising:
establishing a plurality of contracting healthcare service providers;
providing a case statement template having one or more areas to specify clinical and non-clinical requirements of the patient;
extracting case statement information, at least a portion of which is provided by the patient, from the case statement template;
preparing a case statement based on the case statement information;
establishing case statement profile criteria for each of the plurality of contracting healthcare service providers;
making the case statement available to each contracting healthcare service provider whose profile criteria matches the case statement; and
receiving a response to the case statement from at least one contracting healthcare service provider, the response including a price, a clinical track record, and non-clinical information.

29. A method as claimed in claim 28, wherein the response includes information concerning one or more clinical quality indicators for one healthcare service provider.

30. A method as claimed in claim 29, wherein the one or more clinical quality indicators includes the mortality rate for a medical procedure.

31. A method as claimed in claim 29, wherein the one or more clinical quality indicators includes the number of times a medical procedure has been performed.

32. A method as claimed in claim 29, wherein the one or more clinical quality indicators includes the number of times a medical procedure has been performed by a physician associated with one of the one or more contracting healthcare service providers.

33. A method as claimed in claim 28, further comprising reviewing the proposal from the at least one healthcare service provider.

34. A method as claimed in claim 33, wherein reviewing the proposal from the at least one healthcare service provider includes reviewing the proposal with a referring physician.
